(19) United States
(12) Patent Application Publication
(10) Pub. No.: US 2003/0036954 A1
(43) Pub. Date: Feb. 20, 2003

(54) Method for increasing business revenue

(76) Inventor: Barry D. Rayment, Laguna Beach, CA (US)

Correspondence Address: Rob Phillips, 1397 Via Merano, Henderson, NV, 89052, US

(21) Appl. No.: 09/932,781

(22) Filed: Aug. 20, 2001

(51) Int. Cl. G06F 17/60; G06F 17/00

(52) U.S. Cl. 705/14; 705/500

(57) ABSTRACT

A method for increasing business revenue particularly suited for the restaurant business includes a first customer visit, an authorized customer payment above the purchase price, proof of payment of the additional sum, a predetermined discount associated with a second customer visit. The customer authorizes the restaurant or other business entity to charge an additional sum of money on a credit card or pays the additional sum in cash in return for proof of payment of the additional sum. The payment of the additional sum provides the customer with a predetermined discount on a second visit along with a refund of the additional sum paid during the first visit A computer processor can assist with tracking customers participating in the method The additional sums paid and the predetermined discount may be altered to meet particular needs of different businesses

### FIELD OF THE INVENTION

The present invention relates to a business method more particularly a method of increasing restaurant revenue by increasing repeat business at the restaurant. Customers at a chosen restaurant are encouraged through a future discount to return to the chosen restaurant at some time in the future. The business method is especially conducive to the restaurant business but other retail businesses will benefit from use of the method as well.

### BACKGROUND OF THE INVENTION

The number of restaurants in any given city seems to increase on a daily basis. Unfortunately, it is commonly known that 50% or more of new restaurants fail in their first year of business. There is no shortage of reasons for the high failure rate including poor management, poor location and poor quality of food and service. However, the prime reason restaurants fail is the shear number of choices for restaurant patrons. With so much competition in the restaurant business it is desired to increase the number of first time customers and to further increase the number of customers who return consistently.

Restaurants, like other businesses, rely on advertising and word of mouth to generate customer flow. Restaurant advertisements proliferate television, radio and the internet. However, such advertising is simply not that effective in the restaurant industry unless directed to fast food Burger King®, McDonalds®, and others have large advertising budgets and benefit from saturation advertising. Local restaurant chains and mom and pop operations do not have the monetary budgets to place endless ads. Therefore, local restaurant chains and mom and pop operations must insure that customers continue to return and frequent their establishments. The method of the present invention provides a simple and effective system to insure that customers frequent a particular establishment and further insures the establishment profits in a predetermined amount regardless of whether the customer returns.

Business methods patents have been filed with increasing frequency and many are directed to motivating a customer to return to an establishment beyond an initial visit. U.S. Pat. No. 6,193,608 issued to Walker discloses a “Method for Motivating Players to Return to a Casino Using Premiums” The method includes the casino providing a player cashing in his casino chips a negotiable instrument rather than cash. The negotiable instrument includes a premium amount above and beyond the amount of the chips cashed in by the player. The premium amount is paid to the player if, and when, he cashes the negotiable instrument at the issuing casino. This method requires the player to leave his cash tied up in a negotiable instrument causing the player to lose a certain level of monetary freedom.

U.S. Pat. No. 5,924,078 issued to Naftzger discloses a “Consumer-Provided Promotional Code Actuatable Point-of-Sale Discounting System.” A point-of-sale system compares a promotion code with a stored promotion code and if the codes match the customer is given a discount at the point-of-sale. The system disclosed does not effectively insure the customer given the instant discount will return in the future.

U.S. Pat. No. 6,196,458 issued to Walker discloses “A Method and Apparatus for Printing a Billing Statement to provide Supplementary Product Sales” The method comprises the addition of a product sale offer on a customer's billing statement based on the previous purchases on the billing statement. The method tracks previous customer purchases and attempts to sell the customer a related sale item on the next issued billing statement. The method is effective at increasing additional limited purchases but does not anticipate a restaurant environment nor do customers desire to be burdened by continuous unsolicited sales offers.

The method described by the present invention includes a business locale preferably a restaurant, a first customer payment, a second authorized customer payment, proof of second authorized customer payment, a repeat visit to the business locale wherein the customer is returned the second authorized customer payment and is further awarded a predetermined discount on the current purchase.

In a preferred embodiment a restaurant customer enjoys and thereafter pays for a meal. Whether paying by cash or credit the customer will be asked to pay an additional small sum of money (e.g. $10.00) in addition to the meal price and gratuity. The additional small sum can be in the form of cash or applied to a credit card. The customer will be given proof of payment of the additional small sum of money. Upon returning to the establishment the customer will be refunded the small sum and will be given a predetermined meal discount (e.g. 15%). Should the customer not return, the establishment retains and profits by the additional small sum paid on the initial visit by the customer. In the present method the establishment generates revenue and profit whether the customer returns or not.

The method can be tailored to accommodate any type of restaurant. In other words, the additional small sum can be determined by the restaurant's customer profile (e.g. wealthy, middle-class or lower class) and the subsequent discount can be determined by the restaurant's profit margin and related financial figures. Seasonal considerations may also be analyzed to determine the most efficient and reliable discount figure.

It is further envisioned that larger restaurant chains may permit its customers to take advantage of the discount at any participating restaurant location. Therefore, if a customer initially visits a restaurant chain in Las Vegas and receives proof of payment of the additional sum, the customer can redeem the discount at a different participating restaurant chain location in a different location (e.g. Phoenix). Should the restaurants act independently such as in a franchise situation smaller or larger discounts may apply to a different chain location.

The proof of payment of an additional sum may be depicted on the credit card receipt, the meal receipt from the cash register or in the form of a coupon. In another embodiment, the customer's information is entered into a computer database upon payment of the additional sum. Thereafter, the computer automatically applies the discount based on the customer providing positive identification. The computer can be a conventional personal computer (P.C.) With sufficient memory to store the information necessary to implement the method.

### SUMMARY OF THE INVENTION

The present invention solves the problems inherent with the previous methods as disclosed herein. It is an object of the present method to increase repeat customer business.

It is a further object of the present invention to increase the revenue generated by a particular business.

It is a further object of the present invention to build customer loyalty through a simple, inexpensive and efficient procedure.

Other objects, features and advantages of the present invention will be readily apparent from the following description of certain preferred embodiments. It is understood that modifications and variations may be effectuated without departing from the spirit and scope of the present invention.

### BRIEF DESCRIPTION OF THE DRAWINGS

FIG. 1 is flow chart of the present business method;

FIG. 2 is a flow chart of the present business method utilizing a computer to track customer information.

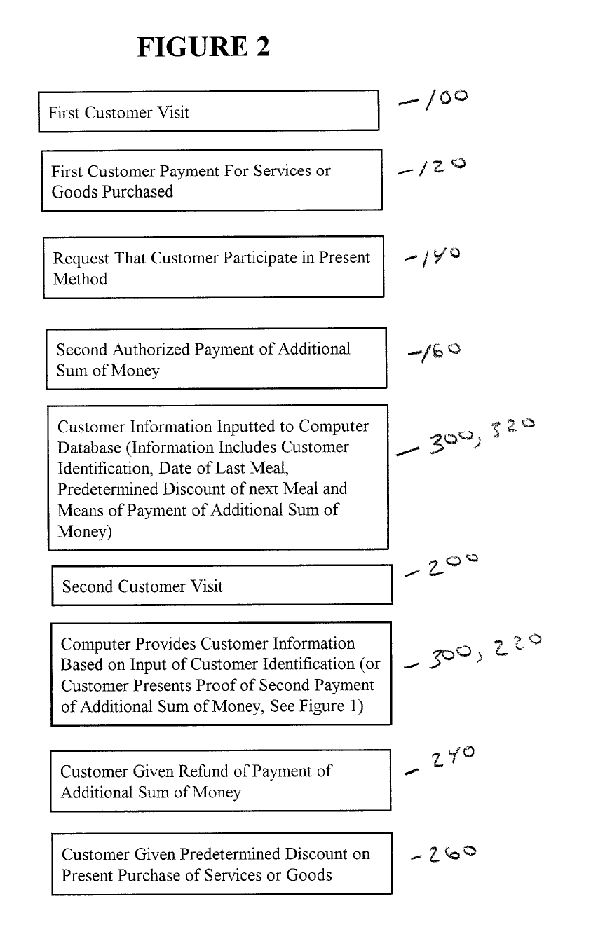

### DETAILED DESCRIPTION OF THE PREFERRED EMBODIMENTS

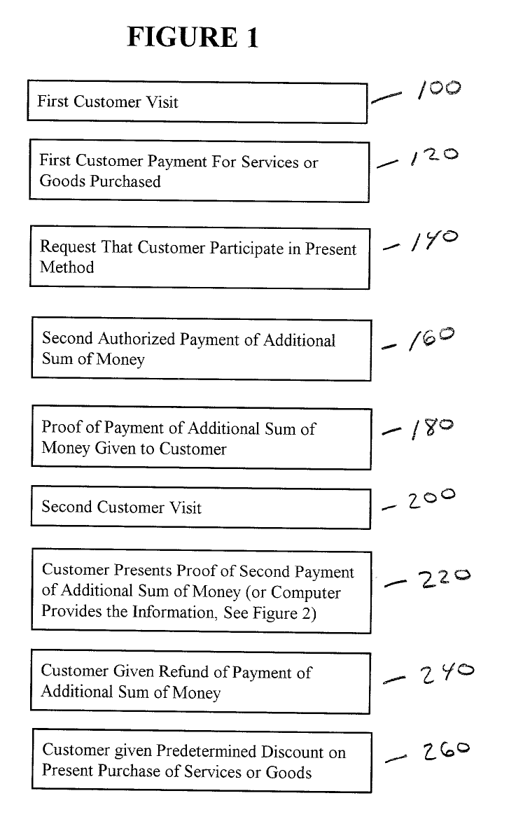

FIG. 1 shows a block diagram of the present method including a first payment 120, a second authorized payment 160, proof of a second authorized payment 180, a second customer visit 200, proof of second authorized payment 220, a refund of second authorized payment to customer 240 and a predetermined discount 260 applied to the customer's current purchases.

While many business environments may benefit from the present method, the detailed description is directed toward the business of a restaurant

A first customer visit 100 results in an ordered meal and presentation of payment means 120. Upon receiving said means of payment 120 the restaurant employee, typically a waiter or waitress, will explain the method to the customer and request 140 that the customer participate in the present method. It is foreseen that businesses offering its customers the opportunity to participate in the present method will create a catchy name, phrase and/or logo for the program. Should the customer respond in the positive to the employee's offer, the customer will be required to pay an additional sum of money 160 above the cost of the meal including gratuity. The additional sum of money is to be determined by each individual restaurant based on the restaurant's prices, customer base, customer loyalty, etc However, in the preferred embodiment the additional sum is in the range of $5.00 to $25.00. The additional sum of money 160 can be in the form of cash or simply added to the customer's credit or debit card payment.

Once the customer has paid the additional sum of money 160, he or she is given proof of payment 180 of the additional sum of money 160. The proof of payment 180 can be in the form of a credit card receipt, cash receipt or a coupon. In a second embodiment of the present method a computer 300 tracks and stores the participating customer's information 320, including customer identification, date of last meal, predetermined discount on customer's next meal and means of payment of the additional sum of money 160. The computer 300 will instruct the restaurant employees that the specific customer is participating in the present method and will further provide all necessary information to the employees.

A second customer visit 200 provides the customer with an opportunity to enjoy the benefits of the present method. The customer presents the restaurant with proof of payment 220 in the form of a credit card receipt, cash receipt or a coupon given the customer during the customer's first visit 100. In the second embodiment, the computer 300 will determine or verify the customer's participation in the program based on the customer's identification information The second customer visit 200 and proof of payment 220 entitles the customer to a refund 240 of the additional sum payment 160 and a predetermined discount 260 to be applied to the current purchases.

The present method may be repeated by the customer paying the additional sum of money 160 on each subsequent visit and realizing a predetermined discount 260 on each subsequent visit as well. The additional sum of money 160 and the predetermined discount 260 may be adjusted on successive visits to encourage the customer's continued participation.

In the event no second customer visit 200 should occur the restaurant retains the additional sum payment 160 and the payment is included in the total revenue realized by the restaurant. The restaurant may also implement a certain pre-defined time for redemption of the predetermined discount 260.

The present method insures the restaurant will increase profits whether or not the customer returns. However, the present method is designed to create customer loyalty through repeat customer visits which ultimately increase the bottom line.

In both embodiments, the restaurant may send reminders or related information to participating customers in an effort to insure the customer does in fact return and enjoy the benefits of the predetermined discount 260 while increasing customer loyalty of the restaurant

What is claimed is:

1. A method for increasing business revenue including:
a first customer visit;
payment for services and/or goods received during the first visit;
payment of an additional sum of money;
a second customer visit;
a refund of the additional sum; and
a predetermined discount for services or goods received during the second customer visit.

2. The method as defined in claim 1 wherein the customer receives proof of payment of the additional sum of money and presents said proof during the second visit.

3. The method as defined in claim 1 wherein a computer processor tracks customer information of the customers participating in the method.

4. The method as defined in claim 1 wherein the business is a restaurant.

5. The method as defined in claim 1 wherein the predetermined discount is based on the amount of the payment for services or goods received during the first visit.

6. The method as defined in claim 1 wherein the additional sum of money is predetermined in the range of $5.00 to $25.00.

7. The method as defined in claim 1 wherein the additional sum of money is based on the amount of the payment for services or goods received during the first visit.

8. The method as defined in claim 1 wherein the business retains the additional sum of money when no second customer visit occurs within a pre-defined time limit.

9. The method as defined in claim 1 wherein the additional sum of money is paid during each subsequent visit permitting the customer to receive predetermined discounts on each subsequent visit.

10. The method as defined in claim 9 wherein the predetermined discount increases with the payment of each subsequent additional sum of money.

11. The method as defined in claim 9 wherein the additional sum of money paid decreases during each customer visit.

12. The method as defined in claim 9 wherein the business retains the additional sum of money when no subsequent customer visit occurs within a pre-defined time limit.
